(19) United States
(12) Patent Application Publication
(10) Pub. No.: US 2026/0233372 A1
(43) Pub. Date: Aug. 13, 2026

(54) FOLDABLE TOOL WITH POSITIONING MECHANISM

(71) Applicant: Hong Ann Tool Industries Co., Ltd., Taichung City (TW)

(72) Inventor: Cheng-Wei SU, Taichung City (TW)

(21) Appl. No.: 19/353,234

(22) Filed: Oct. 8, 2025

(30) Foreign Application Priority Data
Feb. 8, 2025 (TW) 114104742

(51) Int. Cl. B25F 1/04

(52) U.S. Cl. CPC B25F 1/04

(57) ABSTRACT

A foldable tool includes a body, a tool head assembly, and a positioning mechanism. The tool head assembly has at least one first tool head pivotally connected to the body through a first pivoting portion, with at least one engaging portion formed on an outer periphery thereof. The positioning mechanism includes a positioning button rotatable about a first axis between a locking position and a releasing position. When in the locking position, a locking portion of the positioning button engages the engaging portion to restrict rotation of the tool head relative to the body. When in the releasing position, the locking portion disengages from the engaging portion to allow rotation of the first tool head, and an operating portion of the positioning button protrudes outward from the body along the first axis.

### BACKGROUND OF THE INVENTION

The present invention relates to a foldable tool, and more particularly, to a foldable tool with a positioning mechanism.

Taiwan Utility Patent No. TWM537006 discloses a positioning folding tool, which includes a housing, a support plate, a plurality of tool portions, a fixing portion, and a positioning unit. The support plate is disposed in the housing. The tool portion includes a positioning member having a plurality of grooves and a tool member fixed to the positioning member. The fixing portion includes a fixing member and a locking member. The positioning unit includes an elastic member and a positioning plate. A first end of the positioning plate is pushed by the elastic member so that a second end of the positioning plate is maintained at a first position, in which the tool member and the support plate are fixed at a first angle. By pressing the first end of the positioning plate to compress the elastic member, the second end of the positioning plate is shifted to a second position, in which the tool member is movable relative to the support plate within a range of a second angle.

However, in the above conventional structure, the tool portion and the positioning plate are disposed on opposite sides of the tool. If the user presses the positioning plate first, the tool must then be turned over to view and rotate the tool portion. Conversely, if the tool portion is grasped first, the positioning plate must subsequently be pressed. Such an arrangement leads to inconvenient operation. In addition, the tool portion cannot be too long, since it would otherwise obstruct the positioning plate.

### SUMMARY OF THE INVENTION

An object of the invention is to provide a foldable tool including a body, a tool head assembly, and a positioning mechanism. The tool head assembly includes at least one first tool head having a first pivoting portion pivotally connected to the body and at least one first engaging portion disposed on an outer periphery of the first pivoting portion. The positioning mechanism includes a first positioning button rotatably connected to the body about a first axis between a first locking position and a first releasing position, and provided with a first locking portion and a first operating portion. When the first positioning button is in the locking position, the first locking portion engages the first engaging portion to restrict rotation of the first tool head relative to the body. When the button is in the releasing position, the first locking portion disengages from the first engaging portion to release the restriction, while the first operating portion protrudes outward along the first axis.

The body includes a middle seat integrally formed with two first pivot holes disposed on opposite sides along the first axis. The first positioning button includes a first pin and a first fastening member, the pin having two ends respectively inserted into the pivot holes, while the fastening member is rotatably sleeved thereon and carries the first locking portion. The middle seat is further provided with a first sliding slot on one side, and the body includes a first side cover and a second side cover connected to opposite sides of the middle seat. The first operating portion extends through the sliding slot to protrude outward from one side of the first side cover.

The positioning mechanism further includes a first elastic member having a first coiling portion coiled at least one turn around the first pin. One end of the elastic member is inserted into the middle seat while the other end abuts against the fastening member at a side opposite the first pivoting portion. When the first positioning button is in the releasing position, the fastening member twists and deforms the elastic member, which then provides a restoring force to bias the button toward the locking position. The body further includes a first pivot shaft and two first locking members. The pivot shaft is inserted in the middle seat along a direction parallel to the first axis, and the locking members extend through the covers and threadedly connect to the pivot shaft, with the first pivoting portion sleeved thereon. One side of the middle seat adjacent to the first side cover is further provided with a first limiting hole of non-circular shape, into which a corresponding limiting portion of the pivot shaft is inserted to prevent relative rotation.

The tool head assembly may further include at least one second tool head having a second pivoting portion pivotally connected to the body and at least one second engaging portion on its outer periphery. A second positioning button is rotatably connected to the body about a second axis between a locking position and a releasing position and is provided with a second locking portion and a second operating portion. When the button is locked, the second locking portion engages the second engaging portion to restrict rotation of the second tool head; when released, the locking portion disengages and the operating portion protrudes outward along the second axis. The middle seat includes two second pivot holes on opposite sides, a second pin inserted therein, and a second fastening member rotatably sleeved on the pin and carrying the second locking portion. The middle seat further includes a second sliding slot, and the second operating portion extends through the slot to protrude outward from the first side cover.

The positioning mechanism further includes a second elastic member having a second coiling portion coiled at least one turn around the second pin. One end of the elastic member is inserted into the middle seat and the other end abuts against the second fastening member opposite to the second pivoting portion. When the second positioning button is released, the fastening member twists the elastic member, which provides a restoring force to bias the button toward the locking position. The body further includes a second pivot shaft and two second locking members. The pivot shaft is inserted into the middle seat along a direction parallel to the second axis, and the locking members extend through the covers and threadedly connect to the shaft, with the second pivoting portion sleeved thereon. A non-circular second limiting hole and a corresponding limiting portion on the pivot shaft prevent relative rotation between the pivot shaft and the middle seat.

In one configuration, the first and second tool heads are disposed on opposite sides of the body, with the first and second pivoting portions connected to opposite ends of the body. The first tool head has a first working portion opposite to its pivoting portion, and the second tool head has a second working portion opposite to its pivoting portion. When folded, the first working portion is adjacent to the second pivoting portion and the second working portion is adjacent to the first pivoting portion. When unfolded, the working portions extend away from one another. Dimensional relationships are defined such that the distances from the fastening members to the pivot shafts are less than the distances from the working portions to the pivot shafts, thereby improving leverage and usability.

Both the first engaging portions and second engaging portions may be provided in plural, allowing the tool heads to be fixed selectively at a folded position, a 90-degree unfolded position, or a 180-degree unfolded position. The first and second tool heads may further include outer peripheral surfaces formed as flat surfaces between adjacent engaging portions, extending tangentially along the pivot shafts. Moreover, multiple first tool heads may be pivotally connected to the first pivot shaft and arranged side by side along its axis, and multiple second tool heads may likewise be connected to the second pivot shaft and arranged side by side along its axis.

Accordingly, the invention provides a foldable tool with dual tool head assemblies and dual positioning mechanisms, offering reliable locking, selectable angular positioning, enhanced structural stability, and ease of operation.

The present invention will become clearer in light of the following detailed description of illustrative embodiments of this invention described in connection with the drawings.

### BRIEF DESCRIPTION OF DRAWINGS

FIG. 1 is a perspective view of a foldable tool with a positioning mechanism according to the present invention.

FIG. 2 is an exploded perspective view of the foldable tool of FIG. 1.

FIG. 3 is a cross-sectional view of the foldable tool of FIG. 1.

FIG. 4 is another cross-sectional view of the foldable tool of FIG. 1 from a different angle.

FIG. 5 is a cross-sectional view taken along line 5-5 of FIG. 4.

FIG. 6 is a cross-sectional view taken along line 6-6 of FIG. 4.

FIG. 7 is an operational view of the foldable tool, showing the first positioning button moved to the first releasing position.

FIG. 8 is an operational view of the foldable tool, showing the second positioning button moved to the second releasing position.

FIG. 9 is a cross-sectional view of the foldable tool, showing the tool heads in a 45-degree unfolded state.

FIG. 10 is a cross-sectional view of the foldable tool, showing the tool heads in a 90-degree unfolded state.

### DETAILED DESCRIPTION OF THE INVENTION

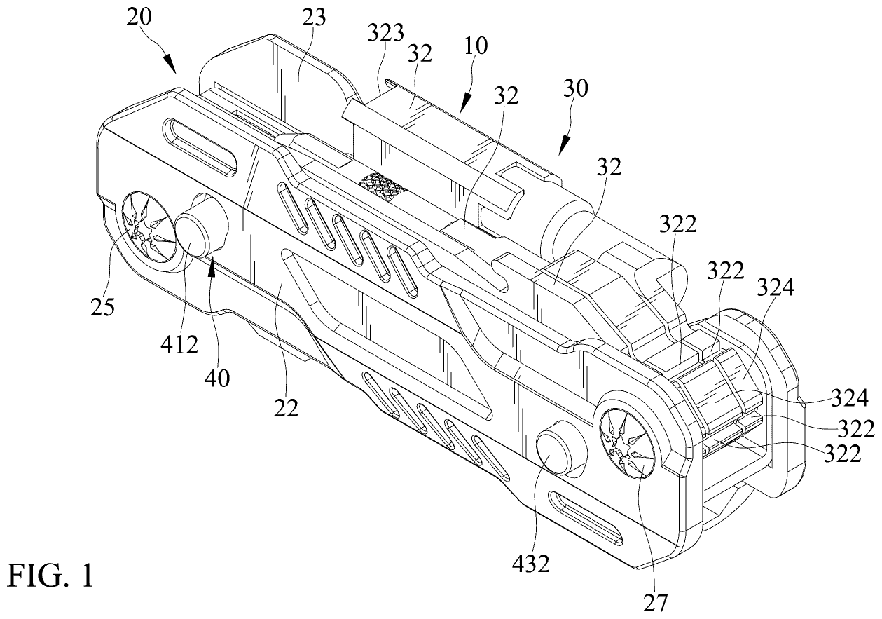

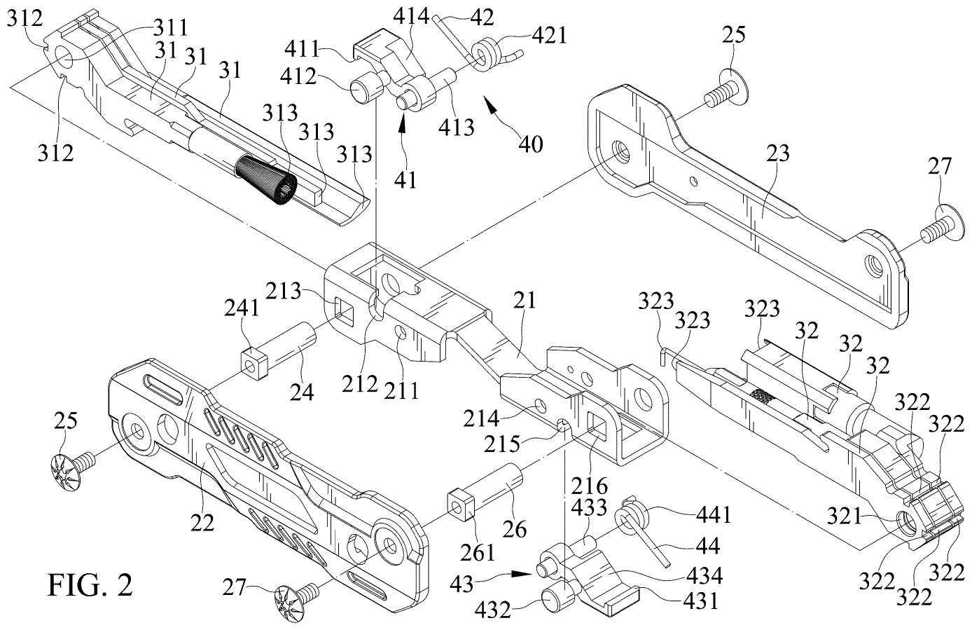

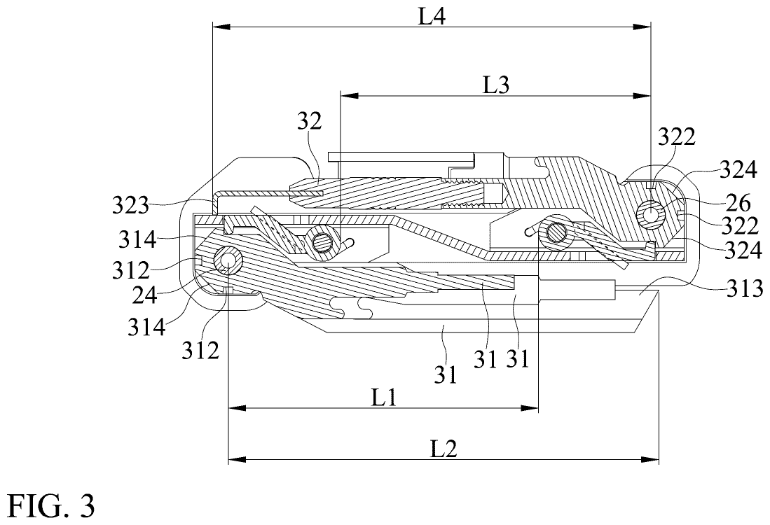

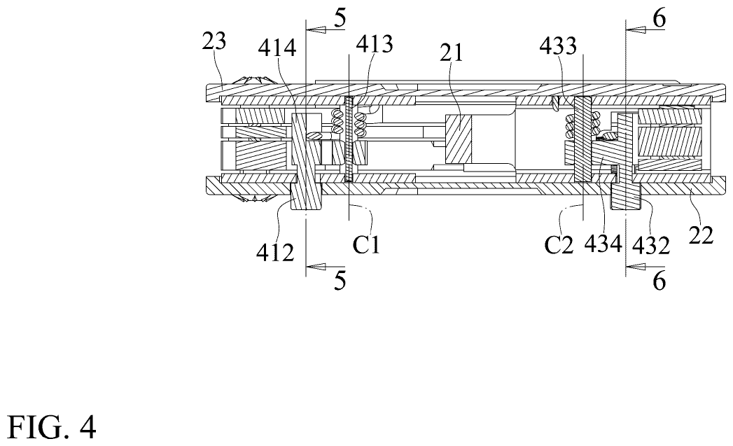

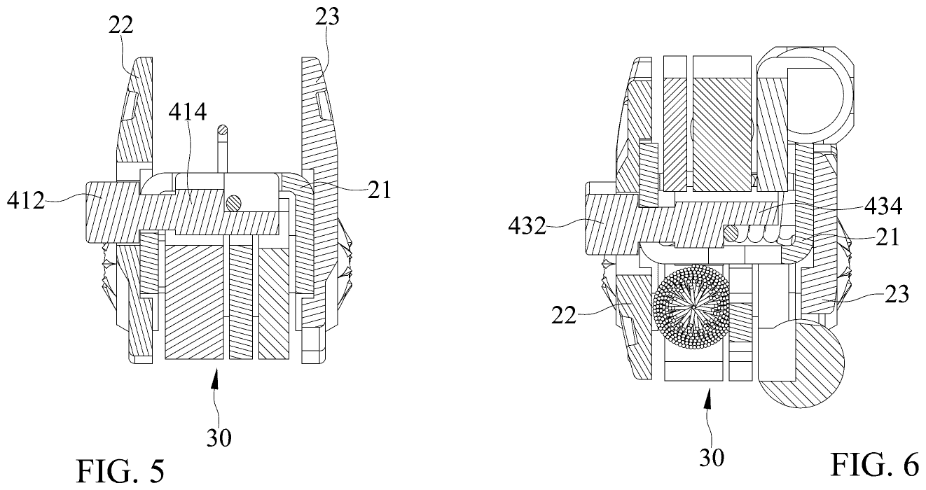

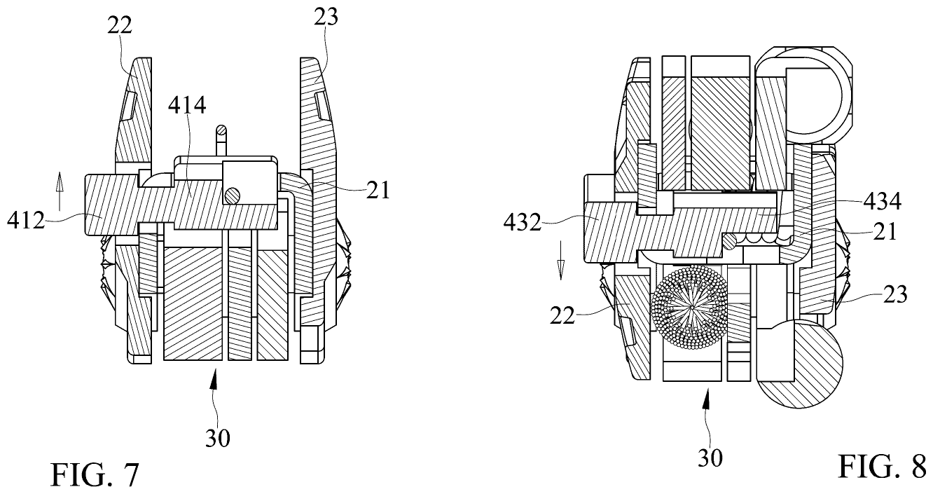

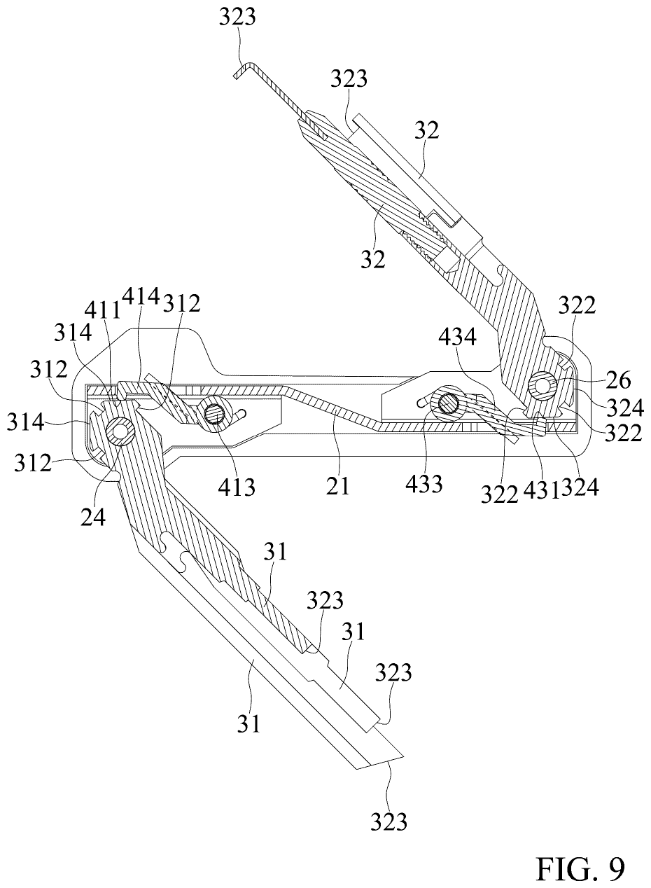

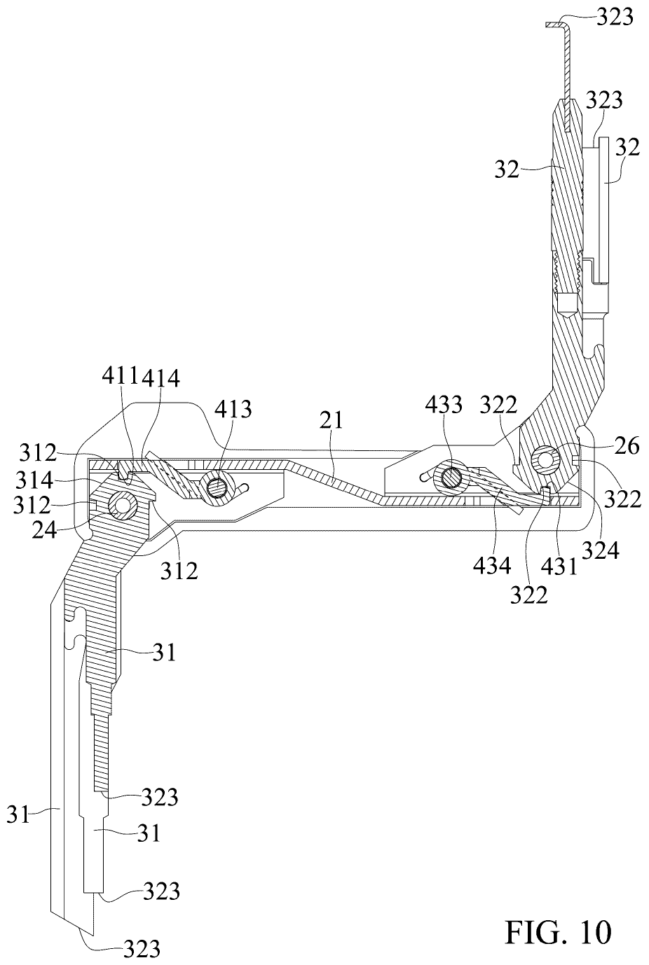

FIGS. 1-10 illustrate a foldable tool 10 according to the present invention. The foldable tool 10 includes a body 20, a tool head assembly 30, and the positioning mechanism 40.

The tool head assembly 30 includes at least one first tool head 31. One end of the first tool head 31 is provided with a first pivoting portion 311 pivotally connected to the body 20, and at least one first engaging portion 312 disposed on an outer periphery of the first pivoting portion 311.

The positioning mechanism 40 includes a first positioning button 41 rotatably connected to the body 20 about a first axis C1 between a first locking position and a first releasing position. The first positioning button 41 is provided with a first locking portion 411 and a first operating portion 412. When the first positioning button 41 is in the first locking position, the first locking portion 411 engages with the first engaging portion 312 to restrict rotation of the first tool head 31 relative to the body 20. When the first positioning button 41 is in the first releasing position, the first locking portion 411 is disengaged from the first engaging portion 312 to release the restriction of rotation of the first tool head 31 relative to the body 20, and the first operating portion 412 protrudes outward from the body 20 along the first axis C1.

The body 20 includes a middle seat 21 formed as an integral structure. The middle seat 21 is provided with two first pivot holes 211 respectively disposed on two opposite sides thereof along the first axis C1. The first positioning button 41 includes a first pin 413 and a first fastening member 414, wherein two ends of the first pin 413 are respectively inserted into the two first pivot holes 211. The first fastening member 414 is disposed in the middle seat 21 and rotatably sleeved on the first pin 413 about the first pin 413. The first locking portion 411 is provided on the first fastening member 414.

The middle seat 21 is provided with a first sliding slot 212 on one side thereof along the first axis C1. The body 20 further includes a first side cover 22 and a second side cover 23 respectively connected to the two opposite sides of the middle seat 21 along the first axis C1. The first operating portion 412 is disposed on the first fastening member 414 and extends through the first sliding slot 212 so as to protrude from one side of the first side cover 22 opposite to the middle seat 21.

The positioning mechanism 40 further includes a first elastic member 42 provided with a first coiling portion 421 disposed between two ends of the first elastic member 42. The first coiling portion 421 is coiled for at least one turn and sleeved on the first pin 413. One end of the first elastic member 42 is inserted into the middle seat 21 and another end of the first elastic member 42 abuts against one side of the first fastening member 414 opposite to the first pivoting portion 311. When the first positioning button 41 is in the first releasing position, the first fastening member 414 pushes the first elastic member 42 to be twisted and deformed, and the first elastic member 42 provides a restoring force to bias the first positioning button 41 toward the first locking position.

The body 20 further includes a first pivot shaft 24 and two first locking members 25. The first pivot shaft 24 is inserted in the middle seat 21 along a direction parallel to the first axis C1. The two first locking members 25 respectively extend through the first side cover 22 and the second side cover 23 from sides opposite to the middle seat 21 and are threadedly connected to the first pivot shaft 24. The first pivoting portion 311 is sleeved on the first pivot shaft 24.

One side of the middle seat 21 adjacent to the first side cover 22 is provided with a first limiting hole 213 having a non-circular shape. One end of the first pivot shaft 24 adjacent to the first side cover 22 is provided with a first limiting portion 241 disposed on an outer periphery thereof along a radial direction of the first pivot shaft 24 and having a shape corresponding to the first limiting hole 213. The first limiting portion 241 is inserted into the first limiting hole 213 to prevent the first pivot shaft 24 from rotating relative to the middle seat 21.

The tool head assembly 30 further includes at least one second tool head 32. One end of the second tool head 32 is provided with a second pivoting portion 321 pivotally connected to the body 20, and at least one second engaging portion 322 disposed on an outer periphery of the second tool head 32. The positioning mechanism 40 further includes a second positioning button 43 rotatably connected to the body 20 about a second axis C2 between a second locking position and a second releasing position. The second positioning button 43 is provided with a second locking portion 431 and a second operating portion 432.

When the second positioning button 43 is in the second locking position, the second locking portion 431 engages with the second engaging portion 322 to restrict rotation of the second tool head 32 relative to the body 20.

When the second positioning button 43 is in the second releasing position, the second locking portion 431 is disengaged from the second engaging portion 322 to release the restriction of rotation of the second tool head 32 relative to the body 20, and the second operating portion 432 protrudes outward from the body 20 along the second axis C2.

The middle seat 21 is further provided with two second pivot holes 214 respectively disposed on two opposite sides along the second axis C2. The second positioning button 43 includes a second pin 433 and a second fastening member 434, wherein two ends of the second pin 433 are respectively inserted into the two second pivot holes 214. The second fastening member 434 is disposed in the middle seat 21 and rotatably sleeved on the second pin 433 about the second pin 433. The second locking portion 431 is provided on the second fastening member 434.

The middle seat 21 is further provided with a second sliding slot 215 on one side thereof along the second axis C2. The second operating portion 432 is disposed on the second fastening member 434 and extends through the second sliding slot 215 so as to protrude from one side of the first side cover 22 opposite to the middle seat 21.

The positioning mechanism 40 further includes a second elastic member 44 provided with a second coiling portion 441 disposed between two ends of the second elastic member 44. The second coiling portion 441 is coiled for at least one turn and sleeved on the second pin 433. One end of the second elastic member 44 is inserted into the middle seat 21 and another end of the second elastic member 44 abuts against the second fastening member 434 at a side opposite to the second pivoting portion 321.

When the second positioning button 43 is in the second releasing position, the second fastening member 434 pushes the second elastic member 44 to be twisted and deformed, and the second elastic member 44 provides a restoring force to bias the second positioning button 43 toward the second locking position.

The body 20 further includes a second pivot shaft 26 and two second locking members 27. The second pivot shaft 26 is inserted in the middle seat 21 along a direction parallel to the second axis C2. The two second locking members 27 respectively extend through the first side cover 22 and the second side cover 23 from sides opposite to the middle seat 21 and are threadedly connected to the second pivot shaft 26. The second pivoting portion 321 is sleeved on the second pivot shaft 26.

One side of the middle seat 21 adjacent to the first side cover 22 is provided with a second limiting hole 216 having a non-circular shape. One end of the second pivot shaft 26 adjacent to the first side cover 22 is provided with a second limiting portion 261 disposed on an outer periphery thereof along a radial direction of the second pivot shaft 26 and having a shape corresponding to the second limiting hole 216. The second limiting portion 261 is inserted into the second limiting hole 216 to prevent the second pivot shaft 26 from rotating relative to the middle seat 21.

The first tool head 31 and the second tool head 32 are respectively disposed on two opposite sides of the body 20. The first pivoting portion 311 and the second pivoting portion 321 are respectively pivotally connected to two opposite ends of the body 20. One end of the first tool head 31 opposite to the first pivoting portion 311 is provided with a first working portion 313. One end of the second tool head 32 opposite to the second pivoting portion 321 is provided with a second working portion 323.

When the first tool head 31 and the second tool head 32 are folded, the first working portion 313 is adjacent to the second pivoting portion 321, and the second working portion 323 is adjacent to the first pivoting portion 311.

When the first tool head 31 and the second tool head 32 are unfolded, the first working portion 313 is unfolded away from the second pivoting portion 321, and the second working portion 323 is unfolded away from the first pivoting portion 311.

A distance from the second fastening member 434 to the first pivot shaft 24 defines a first length L1. A distance from the first working portion 313 to the first pivot shaft 24 defines a second length L2 greater than the first length L1. A distance from the first fastening member 414 to the second pivot shaft 26 defines a third length L3. A distance from the second working portion 323 to the second pivot shaft 26 defines a fourth length L4 greater than the third length L3.

In the embodiment, the at least one first engaging portion 312 includes a plurality of first engaging portions 312. When the first positioning button 41 is in the first locking position, the first locking portion 411 engages with one of the plurality of first engaging portions 312 such that the first tool head 31 is fixed in a folded position, a 90-degree unfolded position, or a 180-degree unfolded position. The at least one second engaging portion 322 includes a plurality of second engaging portions 322. When the second positioning button 43 is in the second locking position, the second locking portion 431 engages with one of the plurality of second engaging portions 322 such that the second tool head 32 is fixed in a folded position, a 90-degree unfolded position, or a 180-degree unfolded position.

In the embodiment, the at least one first tool head 31 is provided with a plurality of first outer peripheral surfaces 314 on an outer periphery thereof along the radial direction of the first pivot shaft 24. The plurality of first outer peripheral surfaces 314 are flat surfaces respectively extending along a tangential direction of the first pivot shaft 24, wherein each of the plurality of first outer peripheral surfaces 314 is disposed between two adjacent ones of the plurality of first engaging portions 312. The at least one second tool head 32 is provided with a plurality of second outer peripheral surfaces 324 on an outer periphery thereof along the radial direction of the second pivot shaft 26. The plurality of second outer peripheral surfaces 324 are flat surfaces respectively extending along a tangential direction of the second pivot shaft 26, and wherein each of the plurality of second outer peripheral surfaces 324 is disposed between two adjacent ones of the plurality of second engaging portions 322.

In the embodiment, the at least one first tool head 31 includes a plurality of first tool heads 31 pivotally connected to the first pivot shaft 24 and arranged side by side along an axial direction of the first pivot shaft 24. The at least one second tool head 32 includes a plurality of second tool heads 32 pivotally connected to the second pivot shaft 26 and arranged side by side along an axial direction of the second pivot shaft 26.

The foldable tool 10 provides convenient operation for the user and a more efficient spatial configuration through the above structure. The first operating portion 412 and the second operating portion 432 are disposed on a side of the body 20, such that regardless of whether the first tool head 31 or the second tool head 32 is unfolded, unlocking operation can be performed on an adjacent side surface along the unfolding direction, thereby providing high convenience. The operation of the first positioning button 41 and the second positioning button 43 does not interfere with the first working portion 313 and the second working portion 323, allowing the body 20 to be provided with tool heads that are nearly equal in length to the body 20 itself, thereby improving space utilization.

Although specific embodiments have been illustrated and described, numerous modifications and variations are still possible without departing from the scope of the invention. The scope of the invention is limited by the accompanying claims.

1. A foldable tool, comprising:
a body;
a tool head assembly including at least one first tool head, wherein one end of the first tool head is provided with a first pivoting portion pivotally connected to the body, and at least one first engaging portion disposed on an outer periphery of the first pivoting portion; and
a positioning mechanism including a first positioning button rotatably connected to the body about a first axis between a first locking position and a first releasing position, wherein the first positioning button is provided with a first locking portion and a first operating portion;
wherein when the first positioning button is in the first locking position, the first locking portion engages with the at least one first engaging portion to restrict rotation of the at least one first tool head relative to the body;
wherein when the first positioning button is in the first releasing position, the first locking portion is disengaged from the at least one first engaging portion to release the restriction of rotation of the at least one first tool head relative to the body, and the first operating portion protrudes outward from the body along the first axis.

2. The foldable tool of claim 1, wherein the body includes a middle seat formed as an integral structure, wherein the middle seat is provided with two first pivot holes respectively disposed on two opposite sides thereof along the first axis, wherein the first positioning button includes a first pin and a first fastening member, wherein two ends of the first pin are respectively inserted into the two first pivot holes, wherein the first fastening member is disposed in the middle seat and rotatably sleeved on the first pin about the first pin, and wherein the first locking portion is provided on the first fastening member.

3. The foldable tool of claim 2, wherein the middle seat is provided with a first sliding slot on one side thereof along the first axis, wherein the body further includes a first side cover and a second side cover respectively connected to the two opposite sides of the middle seat along the first axis, and wherein the first operating portion is disposed on the first fastening member and extends through the first sliding slot so as to protrude from one side of the first side cover opposite to the middle seat.

4. The foldable tool of claim 3, wherein the positioning mechanism further includes a first elastic member provided with a first coiling portion disposed between two ends thereof, wherein the first coiling portion is coiled for at least one turn and sleeved on the first pin, and wherein one end of the first elastic member is inserted into the middle seat and another end of the first elastic member abuts against one side of the first fastening member opposite to the first pivoting portion;
wherein when the first positioning button is in the first releasing position, the first fastening member pushes the first elastic member to be twisted and deformed, and the first elastic member provides a restoring force to bias the first positioning button toward the first locking position.

5. The foldable tool of claim 4, wherein the body further includes a first pivot shaft and two first locking members, wherein the first pivot shaft is inserted in the middle seat along a direction parallel to the first axis, wherein the two first locking members respectively extend through the first side cover and the second side cover from sides opposite to the middle seat and are threadedly connected to the first pivot shaft, and wherein the first pivoting portion is sleeved on the first pivot shaft.

6. The foldable tool of claim 5, wherein one side of the middle seat adjacent to the first side cover is provided with a first limiting hole having a non-circular shape, wherein one end of the first pivot shaft adjacent to the first side cover is provided with a first limiting portion disposed on an outer periphery thereof along a radial direction of the first pivot shaft and having a shape corresponding to the first limiting hole, and wherein the first limiting portion is inserted into the first limiting hole to prevent the first pivot shaft from rotating relative to the middle seat.

7. The foldable tool of claim 6, wherein the tool head assembly further includes at least one second tool head, wherein one end of the at least one second tool head is provided with a second pivoting portion pivotally connected to the body, and at least one second engaging portion disposed on an outer periphery of the at least one second tool head;
wherein the positioning mechanism further includes a second positioning button rotatably connected to the body about a second axis between a second locking position and a second releasing position, and wherein the second positioning button is provided with a second locking portion and a second operating portion;
wherein when the second positioning button is in the second locking position, the second locking portion engages with the at least one second engaging portion to restrict rotation of the at least one second tool head relative to the body;
wherein when the second positioning button is in the second releasing position, the second locking portion is disengaged from the at least one second engaging portion to release the restriction of rotation of the at least one second tool head relative to the body, and the second operating portion protrudes outward from the body along the second axis;
wherein the middle seat is further provided with two second pivot holes respectively disposed on two opposite sides along the second axis, wherein the second positioning button includes a second pin and a second fastening member, wherein two ends of the second pin are respectively inserted into the two second pivot holes, wherein the second fastening member is disposed in the middle seat and rotatably sleeved on the second pin about the second pin, and wherein the second locking portion is provided on the second fastening member;
wherein the middle seat is further provided with a second sliding slot on one side thereof along the second axis, and wherein the second operating portion is disposed on the second fastening member and extends through the second sliding slot so as to protrude from one side of the first side cover opposite to the middle seat;
wherein the positioning mechanism further includes a second elastic member provided with a second coiling portion disposed between two ends thereof, wherein the second coiling portion is coiled for at least one turn and sleeved on the second pin, and wherein one end of the second elastic member is inserted into the middle seat and another end of the second elastic member abuts against the second fastening member at a side opposite to the second pivoting portion;
wherein when the second positioning button is in the second releasing position, the second fastening member pushes the second elastic member to be twisted and deformed, and the second elastic member provides a restoring force to bias the second positioning button toward the second locking position;
wherein the body further includes a second pivot shaft and two second locking members, wherein the second pivot shaft is inserted in the middle seat along a direction parallel to the second axis, wherein the two second locking members respectively extend through the first side cover and the second side cover from sides opposite to the middle seat and are threadedly connected to the second pivot shaft, and wherein the second pivoting portion is sleeved on the second pivot shaft;
wherein one side of the middle seat adjacent to the first side cover is provided with a second limiting hole having a non-circular shape, wherein one end of the second pivot shaft adjacent to the first side cover is provided with a second limiting portion disposed on an outer periphery thereof along a radial direction of the second pivot shaft and having a shape corresponding to the second limiting hole, and wherein the second limiting portion is inserted into the second limiting hole to prevent the second pivot shaft from rotating relative to the middle seat.

8. The foldable tool of claim 7, wherein the at least one first tool head and the at least one second tool head are respectively disposed on two opposite sides of the body, wherein the first pivoting portion and the second pivoting portion are respectively pivotally connected to two opposite ends of the body, wherein one end of the at least one first tool head opposite to the first pivoting portion is provided with a first working portion, and wherein one end of the at least one second tool head opposite to the second pivoting portion is provided with a second working portion;
wherein when the at least one first tool head and the at least one second tool head are folded, the first working portion is adjacent to the second pivoting portion, and the second working portion is adjacent to the first pivoting portion;
wherein when the at least one first tool head and the at least one second tool head are unfolded, the first working portion is unfolded away from the second pivoting portion, and the second working portion is unfolded away from the first pivoting portion.

9. The foldable tool of claim 8, wherein a distance from the second fastening member to the first pivot shaft defines a first length, wherein a distance from the first working portion to the first pivot shaft defines a second length greater than the first length, wherein a distance from the first fastening member to the second pivot shaft defines a third length, and wherein a distance from the second working portion to the second pivot shaft defines a fourth length greater than the third length.

10. The foldable tool of claim 7, wherein the at least one first engaging portion includes a plurality of first engaging portions, wherein when the first positioning button is in the first locking position, the first locking portion engages with one of the plurality of first engaging portions such that the at least one first tool head is fixed in a folded position, a 90-degree unfolded position, or a 180-degree unfolded position, and wherein the at least one second engaging portion includes a plurality of second engaging portions, wherein when the second positioning button is in the second locking position, the second locking portion engages with one of the plurality of second engaging portions such that the at least one second tool head is fixed in a folded position, a 90-degree unfolded position, or a 180-degree unfolded position.

11. The foldable tool of claim 10, wherein the at least one first tool head is provided with a plurality of first outer peripheral surfaces on an outer periphery thereof along the radial direction of the first pivot shaft, wherein the plurality of first outer peripheral surfaces are flat surfaces respectively extending along a tangential direction of the first pivot shaft, wherein each of the plurality of first outer peripheral surfaces is disposed between two adjacent ones of the plurality of first engaging portions, wherein the second tool head is provided with a plurality of second outer peripheral surfaces on an outer periphery thereof along the radial direction of the second pivot shaft, wherein the plurality of second outer peripheral surfaces are flat surfaces respectively extending along a tangential direction of the second pivot shaft, and wherein each of the plurality of second outer peripheral surfaces is disposed between two adjacent ones of the plurality of second engaging portions.

12. The foldable tool of claim 7, wherein the at least one first tool head includes a plurality of first tool heads pivotally connected to the first pivot shaft and arranged side by side along an axial direction of the first pivot shaft, and wherein the at least one second tool head includes a plurality of second tool heads pivotally connected to the second pivot shaft and arranged side by side along an axial direction of the second pivot shaft.
